(19) United States
(12) Patent Application Publication
(10) Pub. No.: US 2003/0030681 A1
(43) Pub. Date: Feb. 13, 2003

(54) Enhanced text entry system for wireless devices

(76) Inventors: Jeff S. Vigil, Camas, WA (US); Michael J. Detlef, Vancouver, WA (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/928,856

(22) Filed: Aug. 13, 2001

(51) Int. Cl. G09G 5/00

(52) U.S. Cl. 345/864; 345/760

(57) ABSTRACT

A hand-held wireless telecommunications device is disclosed that is configured to send a preconfigured text message to a recipient through use of a global computer network. The wireless device includes a processor, a user input component, a display, memory and a communications module for communications with the global computer network. The wireless device includes a messaging module that connects the wireless device to the global computer network and enables the user to establish communications with a message web site. The method includes providing a user interface to select a recipient from an address list and selecting a message from a plurality of preconfigured messages. The messaging module receives the address list and the preconfigured messages from the message web site based on a user identification and displays the user interface on the display thereby enabling the user to select a recipient and a message from the preconfigured messages.

### TECHNICAL FIELD

This invention relates generally to hand-held wireless electronic devices, and is more particularly directed toward an enhanced text entry system for entering messages to be sent using a hand-held wireless electronic device.

### BACKGROUND

Computer and communication technologies continue to advance at a rapid pace. Indeed, computer and communication technologies are involved in many aspects of a person's day. For example, many electronic devices being used today have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

One area of growth for computer and communications technologies has been in the handheld wireless device market. Common examples of hand-held wireless devices include cell phones, one-way pagers, two-way pagers and personal digital assistants. These wireless devices allow users to keep in touch with their businesses, clients, coworkers, friends, etc., in almost any location and at almost any time.

Modem hand-held wireless devices typically have one or more processors. The processor(s) usually are interconnected to different external inputs and outputs and function to manage the particular device. For example, a processor in a cell phone may be connected to the keypad that allows a user to dial a telephone number. As more and more features and capabilities are added to these wireless devices, they become more complex.

Along with the growth of computer and communications technologies came the growth and popularity of the Internet and the World Wide Web (“Web”). As hand-held wireless devices became more complex and went from analog to digital, it was possible to enable these wireless devices to connect to the Internet and the Web. This allowed users of these wireless devices to browse the Web and send and receive messages, including email messages, from a variety of locations with only their hand-held wireless telecommunications device. The demands of consumers to be able to easily and quickly communicate with others continues to grow.

Although it is possible to send and receive messages on wireless devices, many users find it cumbersome. User input components of hand-held wireless devices usually do not have the same capabilities as other user input components. For example, a cell phone only has a limited number of keys and, as a result, it often takes a user much longer to compose an email message using a cell phone than it would on a personal computer. Similarly, the handwriting recognition hardware and software typically used by personal digital assistants usually takes longer to enter a message than if a keyboard were used.

In view of the foregoing, many wireless devices used for sending messages may benefit from being able to more easily enter or provide messages to be sent to recipients.

### SUMMARY OF THE INVENTION

A hand-held wireless telecommunications device is disclosed that is configured to send a text message to a recipient through use of a global computer network. The wireless device includes a processor and an input component in electronic communication with the processor for a user to enter user input. The wireless device also includes a display in electronic communication with the processor that displays information to the user. A communications module is in electronic communication with the processor for communications with the global computer network. Memory is also included in electronic communication with the processor for storing data.

The wireless device includes a messaging module comprising instructions that are executable by the processor for implementing a method. The method includes connecting the wireless device to the global computer network, displaying network data received from the global computer network on the display, enabling the user to establish communications with a message web site and providing to the user a recipient user interface to select a recipient. The method also includes providing to the user a message user interface to select a message from a plurality of preconfigured messages. The messaging module receives the preconfigured messages from the message web site based on a user identification and displays the message user interface on the display. This enables the user to select the message from the plurality of preconfigured messages. The method further includes sending the message to the recipient through the global computer network.

The hand-held wireless telecommunications device may be a mobile telephone, a personal digital assistant, or other hand-held wireless telecommunications device. Depending on the type of device that is being used, different types of network data may be used. For example, network data may include WML, HDML, HTML, XML, XHTML, etc.

The message being sent to the recipient may be a text message. In addition, the message may include a token. The messaging module may allow the user to enter token text to replace the token in the message. In one embodiment, the message may be an e-mail.

A web site is also disclosed for editing and storing preconfigured messages to be used with the hand-held wireless telecommunications devices. The web site includes a web server for serving web data to a plurality of wireless devices and a computer that enables operation of the web server. The computer is in electronic communication with a storage device storing instructions that are executable by the computer for implementing a method. The method includes allowing a wireless device to contact the web site via a global computer network, receiving from the wireless device a user identification and sending an address list identified through use of the user identification from the web site to the wireless device. The method also includes sending preconfigured messages identified through use of the user identification from the web site to the wireless device. The web site may store the preconfigured messages on the storage device. From the wireless device, a message may be received. The user selects the message from the preconfigured messages through use of the wireless device. The user further selects the recipient from an address list through use of the wireless device. Further, the method includes sending the message to the recipient through the global computer network.

The method disclosed in relation to the web site may also include sending user interface data to a client computer to present an edit user interface on the client computer and receiving a change from the client computer to change one of the preconfigured messages.

The web site may receive personal information manager (“PIM”) data from a client computer in electronic communication with the web site via the global computer network and store the PIM data on the storage device. The PIM data may be from a personal digital assistant where the PIM data was transferred to the client computer from the personal digital assistant.

The web data being served by the web server may be served to various web clients including, for example, mobile telephones, personal digital assistants, etc.

A method is also disclosed for providing preconfigured messages to a hand-held wireless telecommunications device to be sent to a recipient through use of a global computer network. The method includes establishing electronic communication between the wireless device and the global computer network and establishing electronic communication between the wireless device and a web site storing preconfigured messages. An address list is retrieved from the web site based on a user identification and sent to the wireless device. The method also includes providing to a user a recipient user interface to select a recipient from the address list and retrieving the preconfigured messages from the web site based on a user identification. The preconfigured messages are sent to the wireless device. In addition, the method includes providing to the user a message user interface to select a message from the preconfigured messages and sending the message to the recipient through the global computer network.

A client user interface may also be provided to a client computer via the global computer network to enable the creation of the preconfigured messages that are stored on the web site.

The method may also include receiving PIM data from the client computer in electronic communication with the web site via the global computer network and storing the PIM data on the web site.

### BRIEF DESCRIPTION OF THE DRAWINGS

The present embodiments will become more fully apparent from the following description and appended claims, taken in conjunction with the accompanying drawings.

Understanding that these drawings depict only typical embodiments and are, therefore, not to be considered limiting of the invention's scope, the embodiments will be described with additional specificity and detail through use of the accompanying drawings in which:

FIG. 1 is a network block diagram illustrating a wireless device communicating with a web site via a computer network;

FIG. 2 is a network block diagram illustrating the uploading of data from a PC to the web site;

FIG. 3 is a block diagram illustrating the storage of multiple sets of user data at the web site;

FIG. 4 is a data structure diagram of an embodiment of user data;

FIG. 5 is a data structure diagram of another embodiment of user data;

FIG. 6 is a data structure diagram of an embodiment of a message including tokens;

FIG. 7 is block diagram illustrating hardware components typically used in an embodiment of a hand-held wireless electronic device;

FIG. 8 illustrates an embodiment of a user interface for editing messages;

FIG. 9 illustrates an embodiment of a user interface for use with an embodiment of a wireless device;

FIG. 10 is a flow diagram illustrating an embodiment of a method for preparing and/or editing the preconfigured messages; and

FIG. 11 is a flow diagram illustrating an embodiment of a method for selecting and sending the preconfigured messages.

### DETAILED DESCRIPTION

It will be readily understood that the components of the embodiments as generally described and illustrated in the Figures herein, could be arranged and designed in a wide variety of different configurations. Thus, the following more detailed description of the embodiments of the system and method of the present invention, as represented in the Figures, is not intended to limit the scope of the invention, as claimed, but is merely representative of the embodiments of the invention.

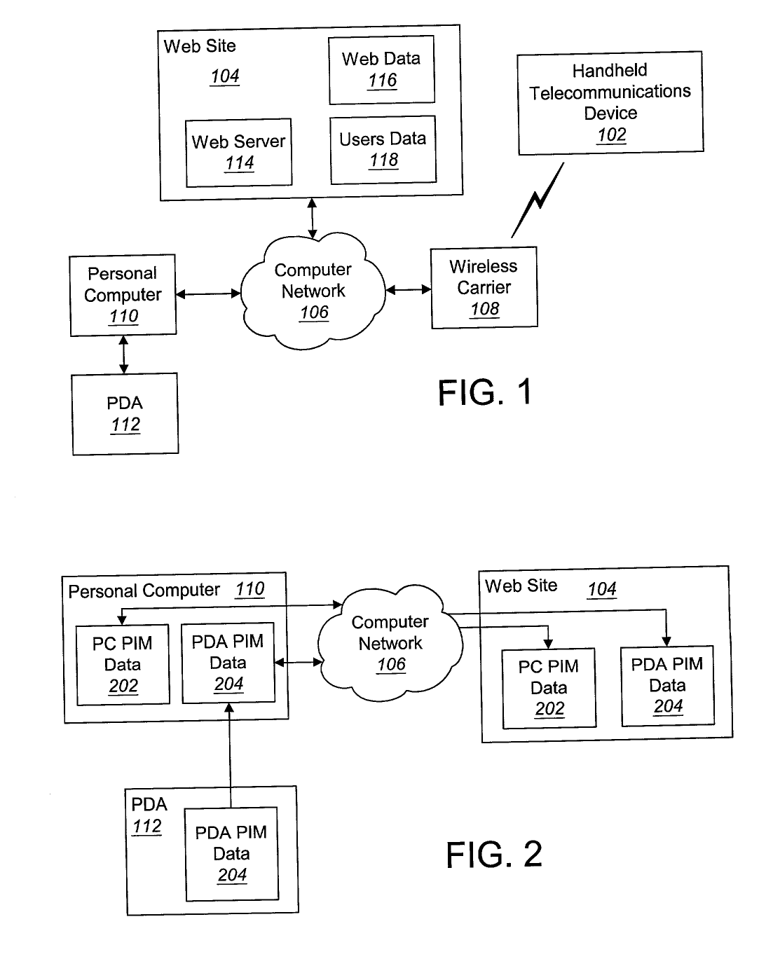

FIG. 1 is a network block diagram illustrating a hand-held wireless telecommunications device 102 communicating with a web site 104 using a computer network 106. The device 102 communicates with the computer network 106 through use of a wireless carrier 108. The wireless carrier 108 provides an interface between the device 102 and the computer network 106. The carrier 108 may include a gateway (not shown) that decodes and encodes messages sent between the device 102 and the computer network 106. For example, in one embodiment where the wireless application protocol (“WAP”) is being used, the wireless carrier 108 may include a WAP gateway (not shown) that encodes/decodes WAP requests to/from a microbrowser of a WAP-enabled device and sends/receives HTTP requests to the computer network 106. Of course, this is just one example of the functionality that may be provided by the wireless carrier 108. Those skilled in the art will appreciate the many additional functions that may be provided by the wireless carrier 108. Wireless carriers 108 are known by those skilled in the art and are being commercially used with various wireless devices and wireless services.

The hand-held wireless telecommunications device 102 may be any portable, hand-held device capable of wireless communications with a computer network 106. Some examples of such hand-held devices 102 are a mobile telephone, a personal digital assistant and a two-way pager. More details of the device 102 will be set forth in relation to FIG. 7.

The computer network 106 may be any of various means for enabling communications between two or more electronic devices and/or computers. For example, the computer network 106 may be include various components including LANs, WANs, the Internet, intranets, direct-cable connections, dial-up connections, etc. The Internet may be referred to as a global computer network.

It is understood that personal computers may be connected to the computer network 106. A personal computer (“PC”) 110 in electronic communication with the computer network 106, or at least capable of connecting to the computer network 106, may also, from time to time, be in electronic communication with a personal digital assistant (“PDA”) 112. The PC 110 and PDA 112 may communicate with one another to synchronize data between the two devices. For example, a user may wish to synchronize appointments made on the PDA 112 with a calendar program (not shown) on the PC 110. Many hardware and software packages are available to synchronize data between a PC 110 and a PDA 112.

A web site 104 may be accessible via the computer network 106. The web site 104 includes a web server 114 that serves web data 116 to users via the computer network 106. Web servers 114 are commercially available. The web data 116 is data served by the web server 114 to users which enables them to browse the web site 104 using a browser (not shown). The web data 116 may includes instructions written in HTML, HDML, WML, XML, XHTML, and the like. In addition, the web data 116 may include Java applets. The serving software may include a Java servlet.

The users data 118 is data that may relate to various users and will be more fully explained below. A web site computer (not shown) is used for hosting the web site 104. Web hosting services are commercially available. Web hosting facilities often include one or more web site computers (not shown) for hosting web sites. These web site computers (not shown) include, or are in communication with, one or more storage devices that are used to store the data relating to the web site 104.

FIG. 2 is a network block diagram illustrating the uploading of data from a PC 110 to the web site 104. The PC 110 may be used to run personal information manager (“PIM”) software (not shown). PIM software typically organizes and stores names, addresses, notes, contact information, a calendar, etc. The different PIM software products available vary in their capabilities, but they all provide methods for a user to manage information used on a daily basis. As shown in FIG. 2, PC PIM data 202 may be stored on the PC 110.

Many PDAs provide PIM software (not shown). Thus, a PDA 112 may store PDA PIM data 204. As a user makes appointments, adds new contacts, modifies other contacts, etc., on his or her PDA 112 the PDA PIM data 204 is modified. As discussed in relation to FIG. 1, many 20 hardware and software components are commercially available for synchronizing data between a PC 110 and a PDA 112. Synchronizing software (not shown) may be used to transfer PDA PIM data 204 to the PC 110. Synchronizing software (not shown) may also be used to translate PDA PIM data 204 to update the PC PIM data 202 or to translate the PC PIM data 202 to update the PDA PIM data 204, etc.

As illustrated, the PC PIM Data 202 and/or the PDA PIM data 204 may be uploaded to the web site 104. As a result, the information contained in the PC PIM data 202 and/or in the PDA PIM data 204 may be used in communicating with the wireless device 102. For example, names, address, telephone numbers, e-mail addresses, etc., may be pulled from the PIM data 202, 204 and sent to the wireless device 102 for use by the user of the wireless device 102. Software may be used to upload the PIM data 202, 204 to the web site 104. For example, the synchronizing software (not shown) may also upload the PIM data 202, 204 to the web site 104. Alternatively, another computer program (not shown) may be used on the PC 110 to update the data 202, 204. If a user desires the PIM data 202, 204 be kept up to date on the web site 104, the PC 110 may be configured to transfer the PIM data 202, 204 to the web site 104 whenever the PDA PIM data 204 synchronizes to the PC 110. Of course, it will be appreciated that the PIM data 202, 204 may also be manually uploaded to the web site 104 by the user when he or she so desires.

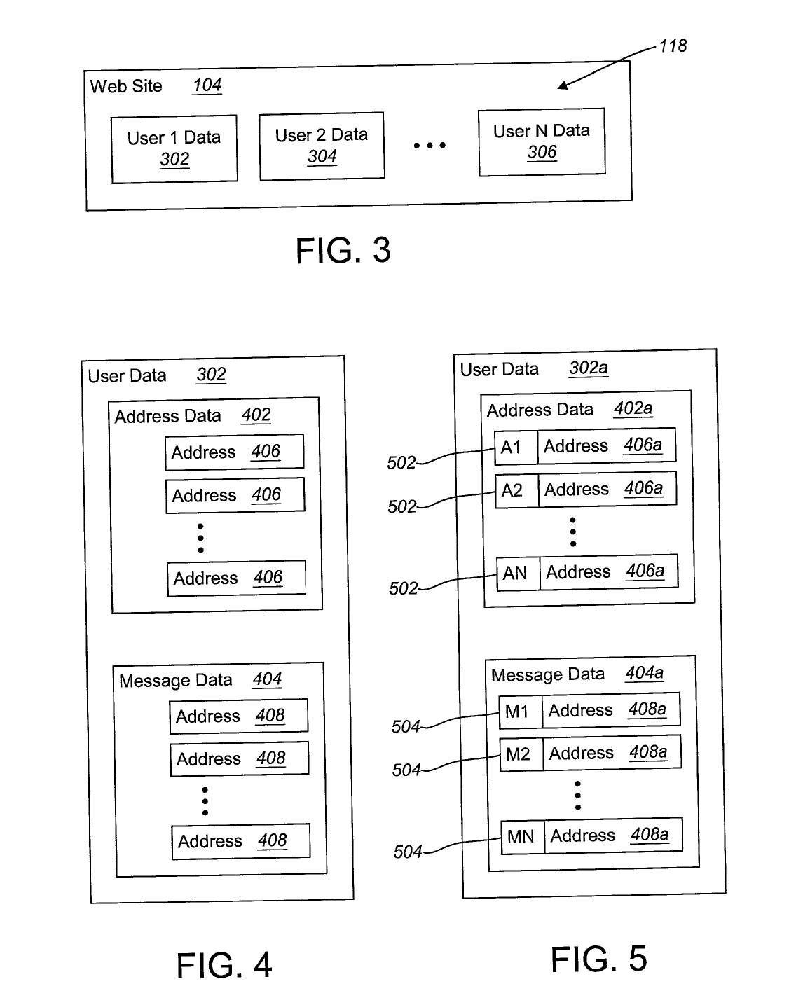

FIG. 3 is a block diagram illustrating the storage of users data 118 at the web site 104. The users data 118 may include a number of individual user data items 302, 304, etc. For example, if N users were using the web site 104 services, there may be N sets of user data items including user 1 data 302, user 2 data 304, and so forth up to user N data 306. As each user (not shown) stores his or her PIM data 202, 204 and/or stores other information (other addresses, contact information, messages, etc.), the web site 104 may store the information for this user in user X data 302, which may be referred to herein as user data 302.

FIG. 4 is a data structure diagram of an embodiment of user data 302. User data 302 may include address data 402 and message data 404. The address data 402 may include one or more addresses 406. The message data 404 may include one or more messages 408. The messages 408 may be in different formats. In one embodiment of the user data 302, the messages 408 may be in text format.

FIG. 5 is a data structure diagram of another embodiment of user data 302a. User data 302a may include address data 402a and message data 404a. The address data 402a may include one or more addresses 406a. Along with each address 406a may be stored an address index 502. The address index 502 may serve as an index to the address with which it is associated. It also may be a shorthand version of the address 406a. For example, if the address 406a included the following information: Name=John H. Doe, Address=101 Street, City=Nice Big City, etc., the address index 502 may be “John”, “Doe”, “JDoe”, etc. In one embodiment of the present system, a list of the address indexes 502 may be sent to the wireless device 102 to select a recipient. However, a more complete list of addresses 406 may also be sent.

The message data 404a may include one or more messages 408a. Along with each message 408a may be stored a message identifier 504. The message identifier 504 may serve as a shorthand form to identify the message 408a and/or may serve as an index to the message 408a with which it is associated. For example, if the message 408a included the following: “Sorry, I am going to be late getting there—I will be there as soon as I can,” the message identifier 504 may be “Late”. In one embodiment of the present system, a list of the message identifiers 504 may be sent to the wireless device 102 to select a preconfigured message. However, a more complete list of preconfigured messages 408a may also be sent.

In operation, when a user of the device 102 desires to send a message, the user interface (not shown) of the wireless device 102 displays a list (not shown) of the preconfigured messages 408 that are available to be selected. Thus, the web site 104 and device 102 are in electronic communication such that the messages 408 that have been preconfigured (prepared beforehand) are communicated to the device 102. The device may provide a user interface (not shown) to the user through which the user may select one or more of the preconfigured messages 408 to send. User interfaces for wireless devices 102 through which items may be presented to a user and selected by a user are well known to those of ordinary skill in the art.

As shown and illustrated in FIGS. 3-5, the web site 104 may include multiple sets of user data 302, 304, etc. Each set of user data 302 may be associated with a particular user. Thus, when a user uses the services provided by the web site 104 or when the user logs in to make changes, the data of his or her own user data 302 set is used. When the user is accessing the data on the web site 104 through the wireless device 102, the wireless device 102 may send a user identification (not shown) to the web site 104 for identifying which set of user data 302 to use and for verifying that he or she is a recognized user of the web site 104. The user identification (not shown) may be sent automatically by the wireless device 102 to the web site 104, or the user may be required to log in to the web site 104 and enter the identification manually. Various types of user identifications include, but are not limited to, user names, passwords, numbers, telephone numbers, and the like.

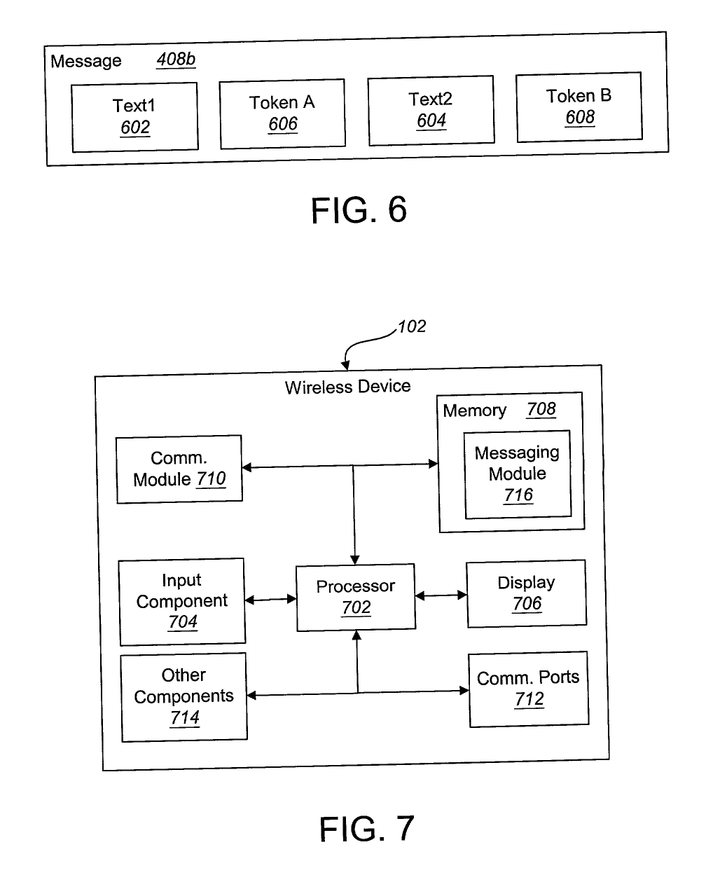

FIG. 6 is a data structure diagram of another embodiment of a message 408b. The message 408b shown in FIG. 6 includes, by way of example, two text portions 602, 604 and two tokens 606, 608. The text1 602 and text2 604 fields may simply be text fields containing one or more alphanumeric characters. Token A 606 and token B 608 are dynamic fields that may be changed by the user before the message 408b is sent to the recipient.

The following example illustrates one possible use of tokens. The following message 408b with tokens may be used: “I am running late and will not be there for [token] minutes. I will try to be there by [token].” With this example, text1 602 is “I am running late and will not be there for” and test2 604 is “minutes. I will try to be there by”. TokenA 606 is a field which the user replaces before sending the message 408b. In this example, the user may replace tokenA 602 with “15” and may replace tokenB 608 with “9:15”. Thus, after the user has replaced the tokens with text, the entire message sent to the recipient will be “I am running late and will not be there for 15 minutes. I will try to be there by 9:15.” Thus, with tokens messages with specific and tailored information may be sent to the recipient but may only require the user to enter minimal input. Of course, it will be appreciated by those skilled in the art that messages 408 with no tokens may be used, as well as messages 408 with many tokens.

FIG. 7 is block diagram illustrating the major hardware components typically utilized in a hand-held wireless electronic device 102. Such electronic devices 102 are widely available (e.g., mobile telephones, PDAs, two-way pagers, etc.). Thus, the block diagram of FIG. 7 is only meant to illustrate the typical components in such a device 102 but is not meant to limit the meaning of a hand-held wireless device 102.

An electronic device 102 typically includes a processor 702 in electronic communication with input components or devices 704 and/or output components or devices 706. The processor 702 is operably connected to input 704 and/or output devices 706 capable of electronic communication with the processor 702, or, in other words, to devices capable of input and/or output in the form of an electrical signal. Embodiments of devices 102 may include the inputs 25 704, outputs 706 and the processor 702 within the same physical structure or in separate housings or structures.

Various types of input components 704 may be used with the wireless device 102. Some typical input components 704 may include, but are not limited to, buttons, keypads, switches, touch screens, voice recognition components and handwriting recognition components. Those skilled in the art will appreciate that various other combinations of hardware and/or software may be used to function as an input component 704.

Different types of output components 706 may be used with the wireless device 102. Typically a display 706 functions as the output component. However, other components may also be used as the output component 706. For example, an audio component (not shown) may be used as the output component 706.

The electronic device 102 may also include memory 708. The memory 708 may be a separate component from the processor 702, or it may be on-board memory 708 included in the same part as the processor 702. For example, microcontrollers often include a certain amount of on-board memory.

The processor 702 is also in electronic communication with a communication module 710. The communication module 710 may be used for communications with other devices 102 or with the computer network 106. Thus, the communication modules 710 of the various devices may be designed to communicate with each other to send signals or messages between the electronic devices 102. Communication modules 710 that may be used with wireless devices 102 are commercially available and known to those of ordinary skill in the art.

The device 102 may also include other communication ports 712. In addition, other components 714 may also be included in the device 102.

A messaging module 716 may be included as part of the wireless device 102 for handling the communications with the computer network 106. The messaging module 716 may include instructions that are executable by the processor 702 for accomplishing certain tasks. The message module 716 establishes communication with the computer network 106. In carrying out this task, and other tasks, the module 716 receives user input through the input component 704 and presents information to the user, usually through use of the display 706. Thus, as data is sent from the web site 104 to the wireless device 102, if the data is to be presented to the user, the messaging module 716 of the wireless device 102 may present that information to the user. In certain embodiments of the messaging module 716, the messaging module 716 may include, or be part of, a microbrowser. WML, HTML, XML, XHTML and/or HDML may be sent to microbrowsers for displaying information to the user.

The messaging module 716 may provide a user interface for the user to use in browsing data and selecting certain pieces of the data. For example, the messaging module 716 may display a list of addresses 406 to the user and provide a means by which the user may select one or more of the addresses 406. The messaging module 716 may also receive a list of preconfigured messages 408 from the web site 104 and display the messages 408 to the user so that the user may select one or more of the messages 408.

Of course, those skilled in the art will appreciate the many kinds of different devices that may be used with embodiments herein. Accordingly, the block diagram of FIG. 7 is only meant to illustrate typical components of an wireless device 102 and is not meant to limit the scope of embodiments disclosed herein.

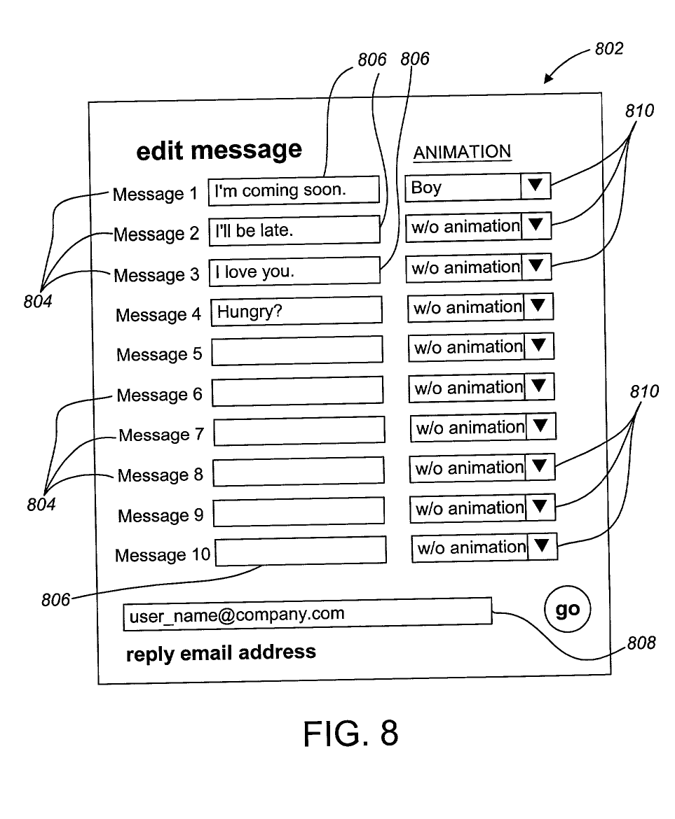

FIG. 8 illustrates an embodiment of a user interface for editing the messages 408. The user interface 802 shown may be displayed through use of a web browser (not shown) on a PC 110. The user interface 802, in one embodiment, is sent from the web site 104 to the PC 110 for display on the PC 110. Message identification text 804 may be displayed to identify the different messages 408. Edit fields 806 may be used to allow the user to enter/edit the preconfigured messages 408. If the messages 408 are e-mail messages, an e-mail address field 808 may be displayed for the user to enter the reply-to email address. Of course, many other items may also be displayed to the user. For example, if certain animations are possible, animation list boxes 810 may be presented to the user for the user to select the kind of animation he or she desires with each message 408. Once the user has made any changes, the data or the new data may be sent back to the web site 104 for storage in the user data 302 for the particular user.

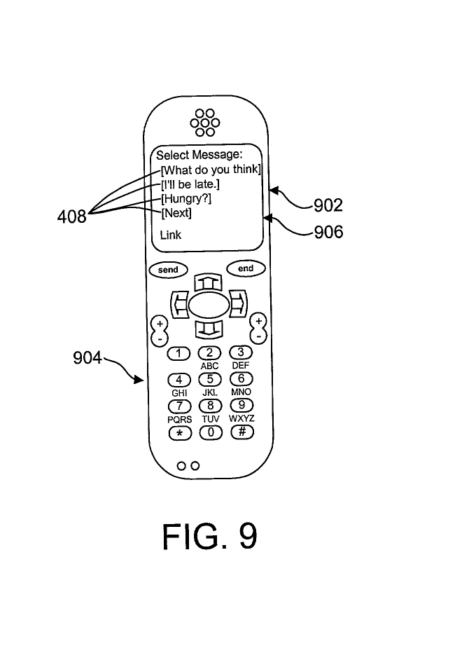

FIG. 9 illustrates an embodiment of a user interface for use with an embodiment of a wireless device 102. For the sake of example, a mobile telephone 902 (e.g., a cell phone) will be used in the illustration of an embodiment for a user interface for the wireless device 902. As shown, the telephone 902 includes a keypad 904 for user input and a display 906 for presenting information to the user. The display 906 illustrates a user interface for the user to view the preconfigured messages 408 and to select a preconfigured message 408. The user interface for selecting a recipient may operate in a similar manner. A plurality of preconfigured messages 408 are displayed to the user on the display 906. Through use of the keypad 904 the user may select one of the messages 408 or scroll to the next screen of messages 408. Depending upon the design of the message module 716, certain portions of the messages 408 may be shown while other portions may not be visible. Through scrolling the user may cause the other portions of the messages 408 to be displayed.

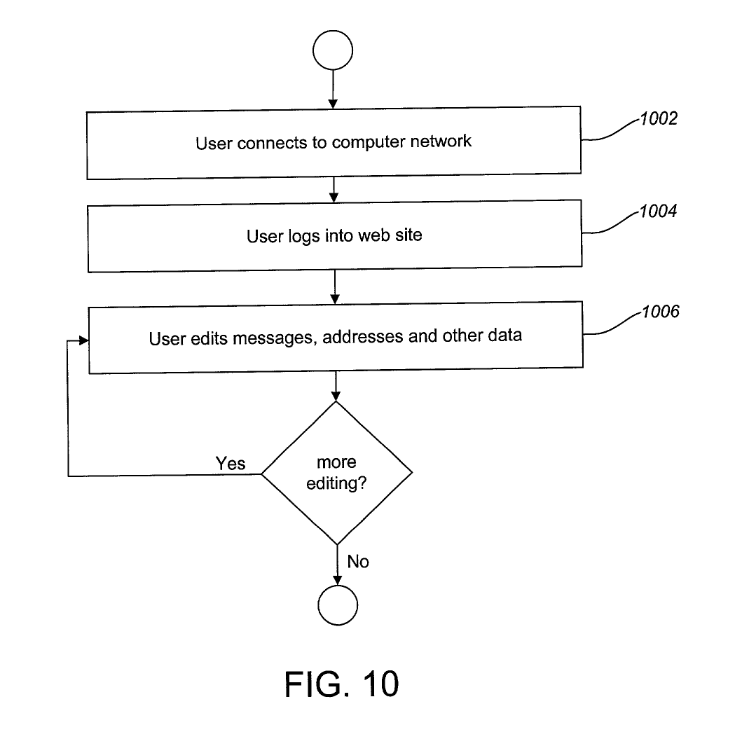

FIG. 10 is a flow diagram illustrating an embodiment of a method for preparing and/or editing the preconfigured messages 408. Typically using a PC 110, a user connects 1002 to the computer network 106. Of course, the PC 110 may already be in electronic communication with the computer network 106. The user may then log 1004 into the web site 104, typically through entry of a username and password. Once the web site 104 has the necessary identification information so that the user's user data 302 may be retrieved, the web site 104 allows the user to enter and/or edit 1006 the preconfigured messages 408. A sample user interface 802 for editing the preconfigured messages 408 is shown in FIG. 8. The user may continue to edit 1006 the preconfigured messages 408 until he or she is done.

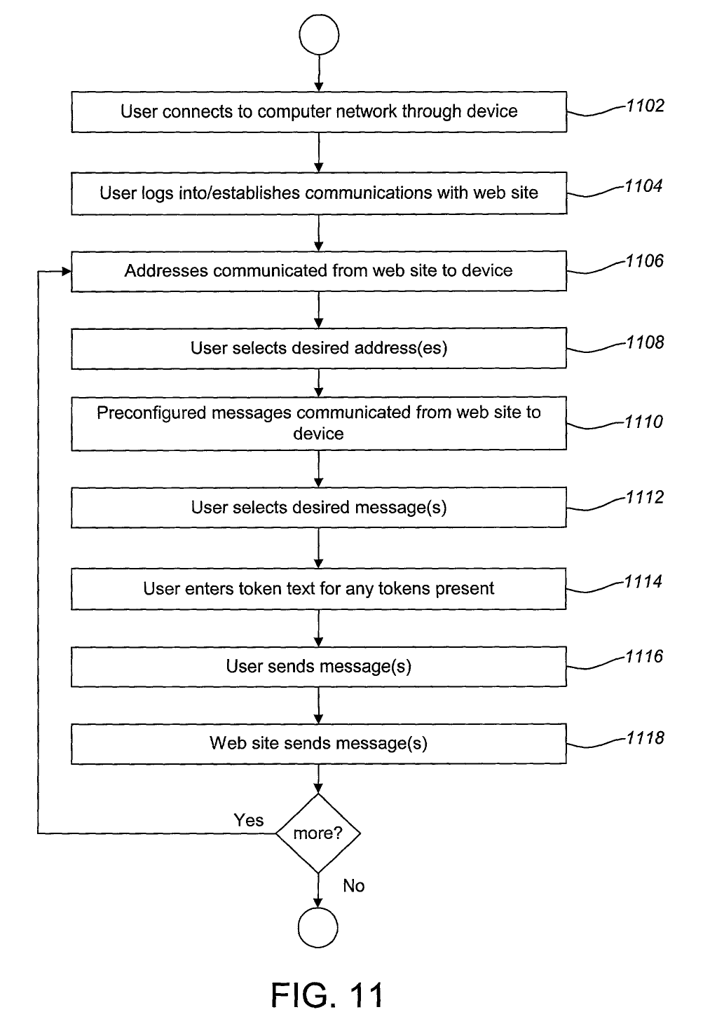

FIG. 11 is a flow diagram illustrating an embodiment of a method for selecting and sending the preconfigured messages 408. Using the wireless device 102, the user connects 1102 to the computer network 106. The user may then log 1104 into or establish communication with the web site 104. The user may need to log 1104 into the web site 104 manually, or the device 102 may automatically send user identification to the web site 104 to automatically log the user in. Once the user has logged in or has otherwise been identified, the web site 104 may then identify the user data 302 associated with that user. Once that user data 302 has been identified, the web site 104 may communicate 1106 addresses 406 to the device 102. Typically the user has entered into a message entry mode and is at the point of entering a destination or recipient address when the addresses 406 are sent to the device 102 from the web site 104. The user selects 1108 the desired address(es) from the list of addresses 408 sent.

Preconfigured messages 408 are sent 1110 from the web site 104 to the device 102. As shown in the example of FIG. 9, the user selects 1112 one or more of the preconfigured messages 408 to send to the recipient(s). If tokens 606 are used in the message 408, the user enters 1114 token text to replace any tokens present. Once the user has selected the desired recipient(s) and the desired preconfigured message(s) 408, he or she may send 1116 the message to the recipient(s). The web site 104 may receive this instruction and send 1118 the message(s). Of course, the user may desire to send more messages and may, therefore, return back to a recipient selection interface and/or a message selection interface.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A hand-held wireless telecommunications device configured to send a text message to a recipient through use of a global computer network, the wireless device comprising:
a processor;
an input component in electronic communication with the processor for a user to enter user input;
a display in electronic communication with the processor that displays information to the user;
a communications module in electronic communication with the processor for communicating with the global computer network;
memory in electronic communication with the processor for storing data;
a messaging module comprising instructions that are executable by the processor for implementing a method comprising:
connecting the wireless device to the global computer network;
displaying network data received from the global computer network on the display;
enabling the user to establish communications with a message web site;
providing to the user a recipient user interface to select a recipient;
providing to the user a message user interface to select a message from a plurality of preconfigured messages, wherein the messaging module receives the plurality of preconfigured messages from the message web site based on a user identification and displays the message user interface on the display thereby enabling the user to select the message from the plurality of preconfigured messages; and
sending the message to the recipient through the global computer network.

2. The hand-held wireless telecommunications device as defined in claim 1, wherein the handheld wireless telecommunications device is a mobile telephone.

3. The hand-held wireless telecommunications device as defined in claim 1, wherein the handheld wireless telecommunications device is a personal digital assistant.

4. The hand-held wireless telecommunications device as defined in claim 1, wherein the message is a text message.

5. The hand-held wireless telecommunications device as defined in claim 1, wherein the message is a text message that includes a token.

6. The hand-held wireless telecommunications device as defined in claim 5, wherein the messaging module allows the user to enter token text to replace the token in the message.

7. The hand-held wireless telecommunications device as defined in claim 1, wherein the message is an e-mail.

8. The hand-held wireless telecommunications device as defined in claim 1, wherein the network data comprises WML.

9. The hand-held wireless telecommunications device as defined in claim 1, wherein the network data comprises HDML.

10. The hand-held wireless telecommunications device as defined in claim 1, wherein the network data comprises HTML.

11. The hand-held wireless telecommunications device as defined in claim 1, wherein the network data comprises XML.

12. The hand-held wireless telecommunications device as defined in claim 1, wherein the network data comprises XHTML.

13. A web site for editing and storing preconfigured messages to be used with hand-held wireless telecommunications devices, the web site comprising:
a web server for serving web data to a plurality of wireless devices;
a computer enabling operation of the web server, the computer being in electronic communication with a storage device storing instructions executable by the computer for implementing a method comprising:
allowing a wireless device to contact the web site via a global computer network;
receiving from the wireless device a user identification;
sending an address list identified through use of the user identification from the web site to the wireless device;
sending a plurality of preconfigured messages identified through use of the user identification from the web site to the wireless device;
receiving a message and a recipient from the wireless device, wherein the message is selected from the preconfigured messages by a user through the wireless device, and wherein the recipient is selected from the address list by the user through the wireless device; and
sending the message to the recipient through the global computer network.

14. The web site as defined in claim 13, wherein the method further comprises storing the preconfigured messages on the storage device.

15. The web site as defined in claim 13, wherein the method further comprises:
sending user interface data to a client computer to present an edit user interface on the client computer; and
receiving a change from the client computer to change one of the preconfigured messages.

16. The web site as defined in claim 13, wherein the method further comprises receiving PIM data from a client computer in electronic communication with the web site via the global computer network and storing the PIM data on the storage device.

17. The web site as defined in claim 13, wherein the method further comprises:
receiving PIM data from a client computer in electronic communication with the web site via the global computer network, wherein the PIM data is for a personal digital assistant transferred to the client computer from the personal digital assistant; and
storing the PIM data on the storage device at the web site.

18. The web site as defined in claim 13, wherein the web server serves the web data to a plurality of mobile telephones.

19. The web site as defined in claim 13, wherein the web server serves the web data to a plurality of personal digital assistants.

20. The web site as defined in claim 13, wherein the preconfigured messages are text messages.

21. The web site as defined in claim 13, wherein the preconfigured messages are text messages that include tokens.

22. The web site as defined in claim 13, wherein the preconfigured messages are text messages that include tokens and wherein each token is editable by the user using the wireless device.

23. The web site as defined in claim 13, wherein the message is an e-mail message and wherein the method further comprises e-mailing the e-mail message to the recipient through the global computer network.

24. The web site as defined in claim 13, wherein the web data comprises WML.

25. The web site as defined in claim 13, wherein the web data comprises HDML.

26. The web site as defined in claim 13, wherein the web data comprises HTML.

27. The web site as defined in claim 13, wherein the web data comprises XML.

28. The web site as defined in claim 13, wherein the web data comprises XHTML.

29. A method for providing preconfigured messages to a hand-held wireless telecommunications device to be sent to a recipient through use of a global computer network, the method comprising:
establishing electronic communication between the wireless device and the global computer network;
establishing electronic communication between the wireless device and a web site storing preconfigured messages;
retrieving an address list from the web site based on a user identification;
sending the address list to the wireless device;
providing to a user a recipient user interface to select a recipient from the address list;
retrieving the preconfigured messages from the web site based on a user identification;
sending the preconfigured messages to the wireless device;
providing to the user a message user interface to select a message from the preconfigured messages; and
sending the message to the recipient through the global computer network.

30. The method as defined in claim 29, further comprising providing a client user interface to a client computer via the global computer network to enable the creation of the preconfigured messages that are stored on the web site.

31. The method as defined in claim 30, further comprising receiving PIM data from the client computer in electronic communication with the web site via the global computer network and storing the PIM data on the web site.

32. The method as defined in claim 30, further comprising receiving PIM data from the client computer in electronic communication with the web site via the global computer network, wherein the PIM data is for a personal digital assistant and had been transferred to the client computer from the personal digital assistant, and storing the PIM data on the web site.

33. The method as defined in claim 30, wherein the wireless device is a mobile telephone.

34. The method as defined in claim 30, wherein the wireless device is a personal digital assistant.

35. The method as defined in claim 29, wherein the message is a text message.

36. The method as defined in claim 35, wherein the message is a text message that includes a token, and wherein the method further comprises entering token text by the user to replace the token.

37. The method as defined in claim 29, wherein the recipient user interface and the message user interface comprise WML instructions.

38. The method as defined in claim 29, wherein the recipient user interface and the message user interface comprise HTML instructions.

39. The method as defined in claim 29, wherein the recipient user interface and the message user interface comprise XML instructions.

40. The method as defined in claim 29, wherein the recipient user interface and the message user interface comprise XHTML instructions.
